(19) United States
(12) Patent Application Publication
(10) Pub. No.: US 2009/0311055 A1
(43) Pub. Date: Dec. 17, 2009

(54) MILLING TOOL AND METHOD, IN PARTICULAR FOR MILLING COMPOSITE MATERIALS

(76) Inventors: Vincenzo Galota, Torino (IT); Aldo Falchero, Avigliana (IT); Guido Mancina, Fino Mornasco (IT)

Correspondence Address: SUGHRUE MION, PLLC, 2100 PENNSYLVANIA AVENUE, N.W., SUITE 800, WASHINGTON, DC, 20037, US

(21) Appl. No.: 12/444,269

(22) PCT Filed: Oct. 4, 2007
(86) PCT No.: PCT/IB2007/002953

§ 371 Date: Jul. 10, 2009

(30) Foreign Application Priority Data
Oct. 9, 2006 (IT) TO2006A000724

(51) Int. Cl. B23C 5/28; B23C 5/16

(52) U.S. Cl. 407/11; 407/119; 407/118; 407/53; 409/131; 408/145

(57) ABSTRACT

The tool (1) according to the invention is equipped with cutting inserts (5) made of polycrystalline diamond and with washing channels cooling the tool from the inside and discharging, through outlet holes (15), jets of compressed air that remove the highly abrasive powders produced during machining from the cutting areas. In this manner, the tool undergoes less abrasion and anyway it can be sufficiently cooled. The particular choice of the material of the cutting inserts makes the tool more abrasion resistant, while conferring it in the whole a longer operating life. The invention also concerns a method of milling composite materials.

### FIELD OF THE INVENTION

The present invention concerns a tool particularly suitable for milling highly abrasive materials, such as for instance composite materials formed by carbon fibres embedded in an epoxy resin.

The invention also concerns a method of using such a milling tool.

### STATE OF THE ART

Several criticalities are encountered during chip forming machining of composite materials comprising carbon fibres impregnated with epoxy resins.

Some of such criticalities are related with problems in cooling the cutting area: the temperature of the composite material in the cutting area must be kept below relatively low values—approximately, of the order of 180° C.—to avoid that exceeding the polymerisation temperature causes burning of the epoxy matrix, thereby deteriorating the mechanical characteristics of the composite material. However, cooling the cutting area is complicated by the impossibility of using lubricants and cooling liquids, which would pollute the composite material to be machined.

Other difficulties are related with the considerable abrasiveness of the above-mentioned composite materials and of the powders created, in place of chips, during tool machining: this causes a quick wear of the cutting edges of the tools.

It is an object of the present invention to provide a tool, a device and a method enabling an efficient tool machining of highly abrasive composite materials, such as for instance composite materials comprising carbon fibres impregnated with epoxy resins.

### SUMMARY OF THE INVENTION

According to a first aspect of the invention, such object is achieved by a milling tool having the features as claimed in claim 1.

According to a second aspect of the invention, such object is achieved by a method of milling a composite material having the features as claimed in claim 21.

The advantages afforded by the present invention will become more apparent to the skilled in the art from the following detailed description of some non-limiting particular embodiments, shown in the following schematic drawings.

### LIST OF THE FIGURES

FIG. 1 is a perspective view of a first embodiment of a milling tool according to the present invention;

FIG. 2 is a cross-sectional view of the tool of FIG. 1, according to section plane A-A;

FIG. 3 is a side view of the tool of FIG. 1;

FIG. 4 is a cross-sectional view, according to a section plane perpendicular to rotation axis AR of the tool, of a detail of a cutting insert of the tool of FIG. 1;

FIG. 5 is a first side view of a second embodiment of a milling tool according to the present invention;

FIG. 6 is a side view of the tool of FIG. 5, taken in a direction orthogonal to that of FIG. 5;

FIG. 7 shows the tool of FIG. 5 when viewed along the rotation axis of the same tool.

### DETAILED DESCRIPTION

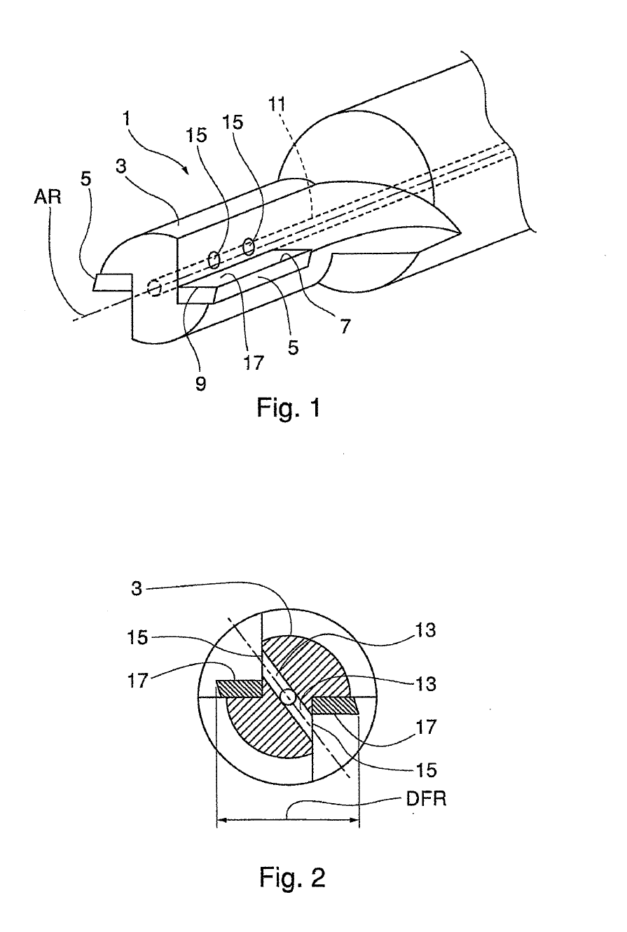

FIGS. 1 to 4 relate to a first embodiment of a milling tool according to the present invention.

Such a tool, generally denoted by 1, includes a cutting-insert holder 3 having, in the present example, the shape of an elongated stem. A pair of cutting inserts 5, each having a side cutting edge 7 and an end cutting edge 9 formed thereon, are secured to holder 3. Side cutting edges 7 enable side milling by tool 1, e.g. for contouring and trimming operations, whereas end cutting edges 9 enable milling by tool 1 while the same is advancing along its rotation axis AR. That is, tool 1 can perform both peripheral milling and end milling.

According to an aspect of the present invention, tool 1 is equipped with washing channels 11, 13 through which a suitable fluid, preferably but not necessarily air, can circulate inside cutting-insert holder 3 and be discharged through multiple outlet holes 15 located close to and opposite cutting surfaces 17 of cutting inserts 5, so as to impinge, possibly directly, on said cutting faces and wash them by jets of compressed air or other fluids, in order to quickly remove from cutting edges 7, 9 powders produced during machining. The highly abrasive powders are thus prevented from quickly wearing and deteriorating cutting edges 7, 9 due to too long a permanence in the spaces between the cutting edges and the surface of the composite material being cut by the same edges. Moreover, a finer roughness, or anyway a better surface finishing, of the surfaces being cut is achieved. Indeed, it is deemed that the powders worsen the roughness of the surfaces being cut.

The cooling and powder removal system operating from the inside of tool 1 has proven more effective than systems operating with air jets from the outside, which other companies were experimenting when the present invention has been conceived and developed.

In the exemplary embodiment of FIGS. 1 to 4, a longitudinal channel 11 and two transverse channels 13 are formed internally of tool 1. The former extends coaxially with and longitudinally of tool 1 and rotation axis AR thereof, and the latter branch off from longitudinal channel 11 transversally of tool 1 and rotation axis AR thereof. In the present description, channels 11 and 13 are also referred to as “washing channels”. In the embodiment of FIGS. 1 to 4, transverse channels 13 emerge outside tool 1 through four outlet holes 15 located close to and opposite cutting surfaces 17 of cutting inserts 5.

The portion of transverse channels 13 near outlet holes 15, and the outlet holes themselves, have preferably a diameter in the range of about 0.5 to 8 mm and, more preferably, of 1 mm to 4 mm.

Number NF of outlet holes 15 washing a given cutting face 17 is preferably determined according to the following relation:

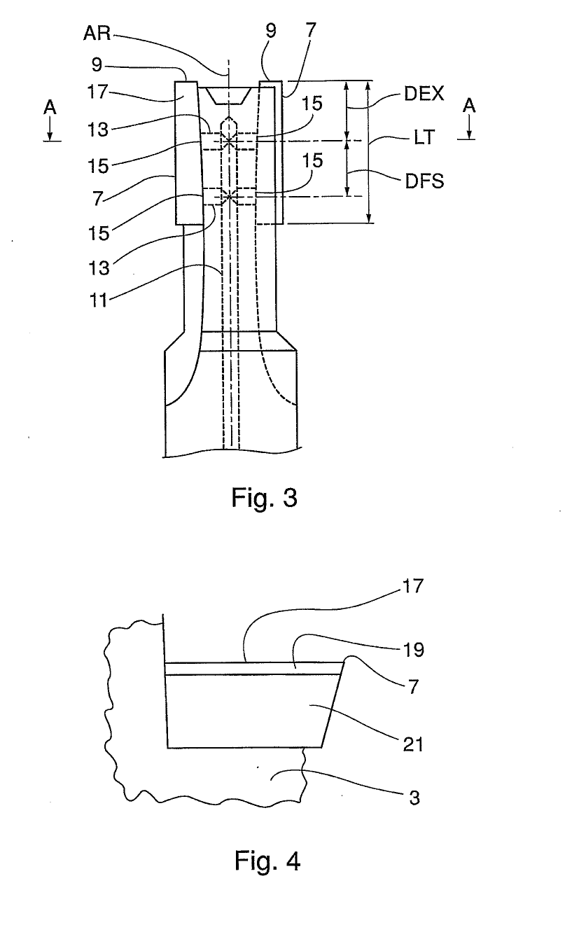

NF=α·LT (1)

where LT is the length of side cutting edge 7 (FIG. 3) in millimetres and a is a multiplication factor ranging from 0.04 to 0.4 and more preferably from 0.08 to 0.18.

Diameter DFO of each outlet hole 15 is preferably determined according to the following relation:

DFO=α·DFR (2)

where DFR is the cutting diameter of the cutter (FIG. 2), i.e. the diameter of the cylinder described by side cutting edges 7, under design conditions, during machining.

Outlet hole 15 closest to the end of tool 1 is preferably spaced apart from said free end, along rotation axis AR, by a distance DEX (FIG. 3) that substantially ranges from two thirds and a quarter of the cutting diameter of the cutter. More preferably, such distance DEX is substantially not lower than a third of the cutting diameter of the cutter.

The axes of two adjacent outlet holes 15 are preferably spaced apart by a distance DFS (FIG. 3) that is substantially not lower than a quarter of length LT of side cutting edge 7.

Side and/or end cutting edges 7, 9 of cutting inserts 5 are formed on a layer of cutting material 19 (FIG. 4) that preferably is polycrystalline diamond—also referred to, in technical jargon, as PCD (PolyCrystalline Diamond) or PDC (Polycrystalline Diamond Compact)—or tungsten carbide (WC). Such a layer 19 preferably comprises synthetic diamond micropowders with a grain size in the range 2 to 30 thousandths of millimetre. The choice of such a material and such a grain size results in a significant improvement to the length of the operating life of tool 1.

Layer 19 of polycrystalline diamond preferably has a thickness not lower than 0.1 5 mm and, more preferably, not lower than 0.4 mm (e.g. a thickness in the range 0.4 to 1.5 mm). Such layer 19 of polycrystalline diamond is preferably sintered on an underlying layer 21 of tungsten carbide, and the overall thickness of layers 19 of polycrystalline diamond and 21 of tungsten carbide is preferably 0.8 to 3.2 mm.

Cutting inserts 5 formed by layer 19 of polycrystalline diamond and layer 21 of tungsten carbide are preferably secured to cutting-insert holder 3 by brazing, and cutting-insert holder 3 too is preferably made of tungsten carbide.

Securing layer 19 of polycrystalline diamond onto substrate 21 of tungsten carbide by sintering and securing cutting inserts 5 to holder 3 by brazing assists in lengthening the operating life of tool 1. Indeed, such securing systems allow obtaining a more robust, compact and monolithic assembly, by reducing vibrations and unwanted movements and making the cutting edges of the tool work in conditions that better approach design conditions. Moreover, such systems, by eliminating or substantially reducing gaps and hollows between cutting inserts 5 and holder 3, if compared to a merely mechanical system for fastening cutting inserts 5, provide for a better conductive heat transmission from the outside towards the inside of tool 1, where washing channels are formed, thereby increasing the cooling effect of the channels. At the same time, cooling the polycrystalline diamond, or other cutting material, improves its abrasion resistance.

By combining the above features, in particular by combining washing channels inside the milling tool with the choice of materials described above, in particular the choice of polycrystalline diamond as cutting material, the operating life of a tool 1 could be increased even by 1,500 to 2,000% or more in comparison to prior art integral, non-cooled tools of tungsten carbide. Indeed, an operating life exceeding 2 m of cutting length has never been attained by said prior art tools while meeting predetermined quality requirements, whereas operating lives even as long as 40 m of cutting length have been attained by the above-described cooled tools of polycrystalline diamond according to the invention. At the same time, by means of a flow of cooling air the temperature in the cutting area could be kept below 180° C., i.e. below the polymerisation temperature of the composite material being milled.

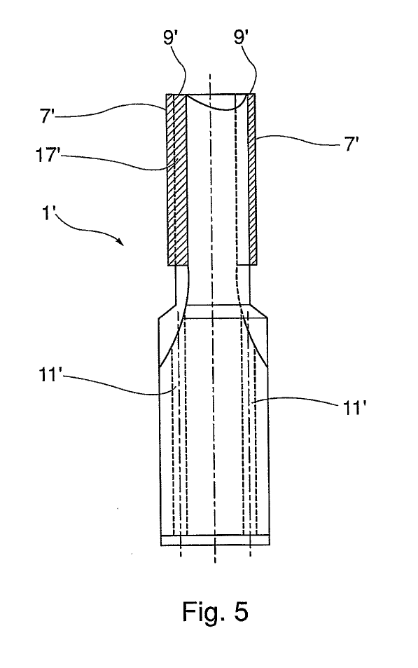

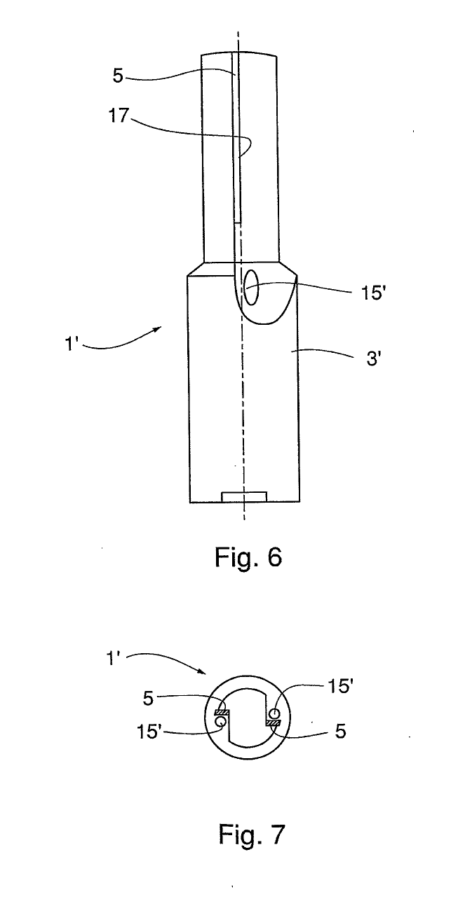

FIGS. 5 to 7 relate to a second embodiment of a milling tool according to the present invention. In such a second embodiment, tool 1′ has two outlet holes 15′ arranged to emit jets of air or another cleaning fluid towards cutting faces 17′, longitudinally of rotation axis of tool 1′ instead of transversally as in the embodiment of FIGS. 1 to 4. Two washing channels 11′, one for each outlet hole 15′, are preferably formed inside tool 1′. Such washing channels 11′ are preferably longitudinally arranged relative to rotation axis AR of the tool, are as much rectilinear as possible and are not coaxial with rotation axis AR, whereas washing channel 11 in the exemplary embodiment of FIGS. 1 to 4 is coaxial with rotation axis AR. The choice of the materials and the system for securing them onto tool 1′ are preferably the same as in the embodiment of FIGS. 1 to 4.

The Applicant has realised that a good cooling of tool 1′ and an effective removal of milling powders from the cutting areas are achieved with such a second embodiment too, even if not so satisfactorily as with the outlet hole arrangement used in the embodiment of FIGS. 1 to 4. In the embodiment of FIGS. 1 to 4, the transverse orientation, relative to rotation axis AR, of the jets of air or another cleaning fluid discharged from outlet holes 15 seems to make removal of offcuts, chips and powders from the cutting areas more effective.

According to a second aspect, the invention concerns a method of milling a composite material comprising a reinforcing material embedded in a polymer matrix. In a particular embodiment of such a method, the reinforcing material of the composite material consists of carbon fibres and such fibres are embedded in a matrix of epoxy resin. Such a composite material is milled by means of tool 1 or 1′ described above, by injecting compressed air into washing channels 11, 13 or 11′.

Several changes and modifications are possible in the exemplary embodiments described above, without departing from the scope of the invention.

For instance, the number of cutting inserts 5, 5′ can obviously be greater or smaller than two. Other cutting materials, such as tungsten carbide, silicon carbide, boron carbide, titanium boride, titanium nitride, aluminium nitride, cubic boron nitride, silicon nitride, alumina, SiAlON or other suitable carbides or nitrides can be used in place of polycrystalline diamond.

Cutting inserts 5, 5′ can even be mechanically secured, e.g. by means of screws or fixed-joint systems, to holders 3 and 3′. In this respect, it will be appreciated that, in the present description, the term “cutting inserts” includes cutting bodies secured to a cutting-insert holder not only by brazing, soldering, sintering or gluing, but also by reversible or irreversible mechanical systems, or other different securing systems. Nitrogen, other inert gases or, still more generally, suitable gaseous substances, such as gases, vapours and aerosols, or yet liquid substances can be used in place of air as washing fluid. Clearly, still further modifications are possible.

1-24. (canceled)

25. A milling tool (1, 1′) arranged to perform milling while rotating about a predetermined rotation axis (AR) and including:
a side cutting edge (7, 7′), substantially located on the sides of the tool (1, 1′);
a cutting face (17), on which possible offcuts, chips and powders produced by the tool (1, 1′) are deposited and flow during machining;
a washing channel (11, 13, 11′), which is formed inside the tool (1, 1′) and through which a cleaning fluid can flow;
wherein the washing channel (11, 13, 11′) emerges outside the tool (1, 1′) through an outlet hole (15, 15′) facing the cutting face (17) so that the cleaning fluid impinges onto the cutting face (17) thereby removing from the side cutting edge possible offcuts, chips and powders produced by the tool (1, 1′) during machining.

26. The tool (1, 1′) as claimed in claim 25, including an end cutting edge (9, 9′) located at the front end of the tool (1, 1′), and an outlet hole (15, 15′) facing the cutting face (17) so that the cleaning fluid impinges onto the cutting face (17) thereby removing from the end cutting edge possible offcuts, chips and powders produced by the tool (1, 1′) during machining.

27. The tool (1, 1′) as claimed in claim 25, wherein at least one out of the side cutting edge (7, 7′) and the end cutting edge (9, 9′) is formed on a layer (19) of a cutting material comprising one or more materials chosen out of the following group: diamond, polycrystalline diamond, carbides, nitrides, tungsten carbide, silicon carbide, boron carbide, titanium boride, titanium nitride, aluminium nitride, cubic boron nitride silicon nitride, alumina.

28. The tool (1, 1′) as claimed in claim 27, wherein the layer (19) of cutting material is formed by sintering.

29. The tool (1, 1′) as claimed in claim 28, wherein the layer (19) of cutting material is formed by sintering diamond powders having a grain size in the range of about 2 to about 30 thousandths of a millimetre.

30. The tool (1, 1′) as claimed in claim 28, wherein the layer (19) of cutting material is formed by sintering on an underlying layer (21) of tungsten carbide.

31. The tool (1, 1′) as claimed in claim 30, wherein the assembly of the layer (19) of cutting material and the underlying layer (21) of tungsten carbide is secured to a cutting-insert holder (3) and the cutting-insert holder (3) is made of a sintered material.

32. The tool (1, 1′) as claimed in claim 31, wherein the sintered material of the cutting-insert holder (3) comprises tungsten carbide.

33. The tool (1, 1′) as claimed in claim 31, wherein the assembly of the layer (19) of cutting material and the underlying tungsten carbide layer (21) is secured to the cutting-insert holder (3) by brazing.

34. The tool (1, 1′) as claimed in claim 25, wherein the outlet hole (15) is arranged to direct a jet of cleaning fluid transversally of the rotation axis (AR) of the tool (1).

35. The tool (1, 1′) as claimed in claim 25, wherein the outlet hole (15) is arranged to direct a jet of cleaning fluid longitudinally of the rotation axis (AR) of the tool (1).

36. The tool (1, 1′) as claimed in claim 25, wherein the outlet hole (15, 15′) has a diameter in the range of about 0.5 mm to 8 mm.

37. The tool (1, 1′) as claimed in claim 36, wherein the outlet hole (15, 15′) has a diameter in the range of about 1 mm to 4 mm.

38. The tool (1, 1′) as claimed in claim 25, wherein the side cutting edge (7, 7′) is so constructed that, while rotating about the rotation axis (AR) of the tool (1, 1′), it describes a cylinder with diameter DFR, and the outlet hole (15) has a diameter (DFO) in the range of about 0.04 to 0.4 times diameter DFR.

39. The tool (1, 1′) as claimed in claim 25, wherein the outlet hole (15) has a diameter (DFO) in the range of 0.08 to 0.18 times diameter DFR.

40. The tool (1, 1′) as claimed in claim 25, wherein the number (NF) of outlet holes (15) arranged to direct jets of the cleaning fluid onto the cutting face (17) is 0.04 to 0.4 times the length (LT) over which the side cutting edge (7, 7′) extends along rotation axis (AR) of the tool (1, 1′).

41. The tool (1, 1′) as claimed in claim 40, wherein the number (NF) of outlet holes (15) arranged to direct jets of the cleaning fluid onto the cutting face (17) is 0.08 to 0.18 times the length (LT) over which the side cutting edge (7, 7′) extends along rotation axis (AR) of the tool (1, 1′).

42. The tool (1, 1′) as claimed in claim 25, wherein the outlet hole (15) closest to one end of the tool (1) is spaced apart from said end by a distance (DEX) that is substantially in the range of two thirds to a quarter of the diameter DFR of the cylinder described by the side cutting edge (7, 7′) while rotating about the rotation axis (AR) of the tool (1, 1′).

43. The tool (1, 1′) as claimed in claim 25, comprising two to twelve side cutting edges (7, 7′).

44. The tool (1, 1′) as claimed in claim 25, comprising one to six outlet holes (15) per cutting face (17).

45. A method of milling a composite material comprising a reinforcing material embedded in a polymer matrix, wherein the method comprises the following steps:
providing a milling tool (1, 1′) as claimed in one or more of the preceding claims;
milling the composite material by means of the tool (1, 1′) while injecting a cleaning fluid into a washing channel (11, 13, 11′) formed inside the tool (1, 1′), so as to remove from a side cutting edge (7, 7′) and/or an end cutting edge (9, 9′) possible offcuts, chips and powders produced during milling.

46. The method as claimed in claim 45, wherein the cleaning fluid is chosen out of the following group: a liquid, a gaseous fluid, a gas, a vapour, aerosols, air, nitrogen, an inert gas.

47. The method as claimed in claim 45, wherein the reinforcing material comprises carbon fibres.

48. The method as claimed in claim 45, wherein the polymeric matrix comprises an epoxy resin.
